(19) United States
(12) Patent Application Publication
(10) Pub. No.: US 2007/0127159 A1
(43) Pub. Date: Jun. 7, 2007

(54) Sintered body for magnetic head slider, magnetic head slider, and method of producing sintered body for magnetic head slider

(75) Inventors: Kei Sugiura, Tokyo (JP); Yukio Kawaguchi, Tokyo (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 11/604,704

(22) Filed: Nov. 28, 2006

(30) Foreign Application Priority Data
Dec. 2, 2005 (JP) P2005-349547

(51) Int. Cl. G11B 5/60

(52) U.S. Cl. 360/235.3

(57) ABSTRACT

A sintered body for a magnetic head slider has at least one of TiC and XC, a carbide containing Ti and X, Al₂O₃, and free carbon, contains 25 to 160 parts by volume of all the carbides including at least one of TiC and XC, and the carbide containing Ti and X, based on 100 parts by volume of Al₂0₃, and contains 1 to 15 parts by volume of free carbon, based on 100 parts by volume of a total of Al₂O₃ and all the carbides (where X is at least one element selected from the group consisting of Ta, W, Mo, Nb, Zr, V, and Cr).

### BACKGROUND OF THE INVENTION

1. Field of the Invention

The present invention relates to a sintered body for a magnetic head slider, a magnetic head slider, and a method of producing a sintered body for a magnetic head slider.

2. Related Background Art

A magnetic head slider incorporating a thin-film magnetic head was first used in a hard disk drive in 1979, and the magnetic head slider at that time is commonly called a mini slider (100% slider). The magnetic head sliders have been downsized through a micro slider (70% slider) having the size of about 70% of the mini slider to a nano slider (50% slider) having the size of about 50% of the mini slider.

Such magnetic head sliders are normally constructed with a laminate incorporating a thin-film magnetic head on a substrate. The magnetic head sliders of this type are obtained by laying the laminate incorporating the thin-film magnetic head, on the substrate to form a laminated structure, thereafter cutting this laminated structure in parallel with the stack direction to form an exposed surface of the thin-film magnetic head, and lapping (or polishing) the exposed surface to form an air bearing surface.

In the production of the conventional magnetic head sliders, for example, as described in Japanese Patent Application Laid-Open No. 57-82172, a high-strength sintered body consisting primarily of alumina and titanium carbide, so called an AlTiC sintered body, is used as the substrate of the magnetic head slider.

### SUMMARY OF THE INVENTION

The magnetic head slider called a pico slider (30% slider) having the size of about 30% of the mini slider is presently mainstream, and it is anticipated that the magnetic head slider will be further downsized with reduction of size and cost of the hard disk drive and that the magnetic head slider will shift to a femto slider (20% slider) having the size of about 20% of the mini slider.

With such downsizing of the magnetic head slider, there arises a demand for reduction in a level difference of the air bearing surface due to a difference between polishing amounts of the substrate and the laminate laid on the substrate, in the lapping step of forming the air bearing surface. There is also a further demand for adequate improvement in surface smoothness of the substrate in the polished air bearing surface.

The present invention has been accomplished in view of the above problem and an object of the invention is to provide a sintered body for a magnetic head slider achieving reduction in the level difference of the air bearing surface and having adequate surface smoothness of the polished surface, a magnetic head slider using it, and a method of producing the sintered body for the magnetic head slider.

The Inventors conducted elaborate research and discovered that a polishing rate of the AlTiC sintered body used as the substrate of the conventional magnetic head slider was much smaller than a polishing rate of the laminate incorporating the thin-film magnetic head and that it caused the polishing amount of the laminate to become much larger than the polishing amount of the substrate during the lapping, resulting in the large level difference. Furthermore, the Inventors came to find the following fact to accomplish the present invention: a polishing rate of a sintered body of a predetermined composition containing at least one of TiC and XC, a carbide containing Ti and X, Al₂O₃, and free carbon (where X is at least one element selected from the group consisting of Ta, W, Mo, Nb, Zr, V, and Cr) was adequately higher than the polishing rate of the conventional AlTiC sintered body and the polished surface became adequately smooth.

A sintered body for a magnetic head slider according to the present invention is one comprising at least one of TiC and XC, a carbide containing Ti and X, Al₂O₃, and free carbon, where X is at least one element selected from the group consisting of Ta, W. Mo, Nb, Zr, V, and Cr, wherein a content of all the carbides including the at least one of TiC and XC, and the carbide containing Ti and X is 25 to 160 parts by volume, based on 100 parts by volume of Al₂O₃, and wherein a content of the free carbon is 1 to 15 parts by volume, based on 100 parts by volume of a total of Al₂O₃ and all the carbides.

A magnetic head slider according to the present invention is one comprising a substrate made from a sintered body, and a laminate incorporating a thin-film magnetic head, which is formed on the substrate, wherein the sintered body comprises at least one of TiC and XC, a carbide containing Ti and X, Al₂O₃, and free carbon, where X is at least one element selected from the group consisting of Ta, W, Mo, Nb, Zr, V, and Cr, wherein a content of all the carbides including the at least one of TiC and XC, and the carbide containing Ti and X is 25 to 160 parts by volume, based on 100 parts by volume of Al₂O₃, and wherein a content of the free carbon is 1 to 15 parts by volume, based on 100 parts by volume of a total of Al₂O₃ and all the carbides.

According to these aspects of the invention, the sintered body has the polishing rate larger than that of the AlTiC sintered body used as the sintered body for the conventional magnetic head slider and, therefore, the difference is sufficiently smaller than before between the polishing rate of the substrate using the sintered body for the magnetic head slider and the polishing rate of the laminate incorporating the thin-film magnetic head. For this reason, a level difference is unlikely to be made between the laminate and the substrate in the air bearing surface formed by lapping, during production of the magnetic head slider and, more particularly, during production of the magnetic head slider by laying the laminate incorporating the thin-film magnetic head, on the substrate made from the sintered body for the magnetic head slider to form the laminated structure and lapping a cross section parallel to the stack direction in the laminated structure. This sintered body for the magnetic head slider has adequate surface smoothness of the polished surface.

If the sintered body contains neither a carbide containing Ti and X, nor XC, but contains only TiC, surface smoothness will tend to be insufficient. If the content of all the carbides including at least one of TiC and XC, and the carbide containing Ti and X is less than the aforementioned lower limit, the polishing rate and surface smoothness will tend to be insufficient. If the content of all the carbides is more than the aforementioned upper limit, sinterability will tend to worsen. If the content of the free carbon is less than the aforementioned lower limit, the polishing rate will be insufficient. If the content of the free carbon is more than the aforementioned upper limit, surface smoothness will be insufficient.

The reason why such tendencies result is not quite clear, but it can be considered, for example, as follows. It can be contemplated that the addition of free carbon in the sintered body containing Al₂O₃ and TiC restrains growth of grains of Al₂O₃, TiC, etc. during sintering and this increases the polishing rate of the sintered body. When the element X, i.e., at least one element selected from the group consisting of Ta, W, Mo, Nb, Zr, V, and Cr, is added in the sintered body, this element is solid-soluble in part with TiC, to form a solid solution of metal carbide, which conceivably improves surface roughness. Namely, X is an element solid-soluble with TiC.

In the sintered body for the magnetic head slider and in the magnetic head slider, preferably, the content of the free carbon is 3 to 7 parts by volume, based on 100 parts by volume of the total of Al₂O₃ and all the carbides. This achieves a higher polishing rate and better smoothness of the polished surface.

Preferably, a molar ratio of X and Ti in all the carbides is 1:3 to 3:1. This adequately improves surface smoothness. When the content of all the carbides is 70 to 160 parts by volume, based on 100 parts by volume of Al₂O₃, the molar ratio of X and Ti in all the carbides may be 1:10 to 3:1. This facilitates the improvement in the polishing rate.

A production method of a sintered body for a magnetic head slider according to the present invention is a method comprising a step of sintering in a non-oxidizing atmosphere a compact of powder comprising Al₂O₃, TiC, XC, and carbon, wherein a total content of TiC and XC is 25 to 160 parts by volume, based on 100 parts by volume of Al₂O₃, and wherein a content of carbon is 1 to 15 parts by volume, based on 100 parts by volume of a total of Al₂O₃, TiC, and XC, provided that X is at least one element selected from the element group consisting of Ta, W, Mo, Nb, Zr, V, Cr, and Si.

This permits us to suitably produce the aforementioned sintered body for the magnetic head slider.

Preferably, the compact contains 3 to 7 parts by volume of carbon, based on 100 parts by volume of the total of Al₂O₃, TiC, and XC. Preferably, in the compact, a molar ratio of XC and TiC is 1:3 to 3:1. Preferably, a total content of all the carbides is 70 to 160 parts by volume, based on 100 parts by volume of Al₂O₃, and a molar ratio of X and Ti in all the carbides is 1:10 to 3:1.

The foregoing production method can further comprise a step of compacting a mixed powder containing Al₂O₃, TiC, XC, and carbon to form the compact.

The method can further comprise a step of mixing Al₂O₃, TiC, XC, and an organic material to obtain a mixture, subjecting the mixture to a thermal treatment in a non-oxidizing atmosphere to carbonize the organic material in the mixture, thereby obtaining a mixed powder, and compacting the mixed powder to form the compact.

Furthermore, the method can further comprise a step of mixing Al₂O₃, TiC, XC, and an organic material to obtain a mixture, compacting the mixture, and subjecting the compacted mixture to a thermal treatment in a non-oxidizing atmosphere to carbonize the organic material in the mixture, to obtain the compact.

The present invention successfully achieves the magnetic head slider having adequate surface smoothness of the air bearing surface and the reduced level difference of the air bearing surface. This permits us to produce the magnetic head slider in a smaller size and to achieve higher density of recording.

### BRIEF DESCRIPTION OF THE DRAWINGS

FIG. 1 is a perspective view of a magnetic head slider according to an embodiment of the present invention.

FIG. 2 is a view taken along II-II in the magnetic head slider of FIG. 1.

FIG. 3 is a perspective view for explaining a production method of magnetic head sliders according to an embodiment of the present invention.

FIGS. 4(a) and 4(b) are perspective views subsequent to FIG. 3 for explaining the production method of magnetic head sliders according to the embodiment of the present invention.

FIG. 5 is a sectional conceptual diagram showing a state in which a bar of FIG. 4(b) has been polished.

FIG. 6 is a table showing formulations of compacts in fabrication of substrates for magnetic heads in Examples 1-9 and Comparative Examples 1-10.

FIG. 7 is a table showing characteristics of magnetic head substrates prepared in Examples 1-9 and Comparative Examples 1-10.

FIG. 8 is XRD data of sintered bodies in Examples 1 and 2, wherein (a) shows the XRD data of surfaces along an axial direction of hot press, and (b) the XRD data of surfaces perpendicular to the axial direction of hot press.

### DESCRIPTION OF THE PREFERRED EMBODIMENTS

Preferred embodiments of the present invention will be described below in detail with reference to the accompanying drawings. In the description of the drawings, identical or equivalent elements will be denoted by the same reference symbols, without redundant description.

(Sintered Body for Magnetic Head Slider)

First, the sintered body for the magnetic head slider according to the present embodiment will be described.

The sintered body for the magnetic head slider according to the present embodiment is a sintered body containing at least one of TiC and XC, a carbide containing Ti and X, i.e., (Ti,X)C, Al₂O₃, and free carbon (C).

However, X is at least one element selected from the group consisting of Ta, W, Mo, Nb, Zr, V, and Cr. This X represents an element group capable of forming a solid solution with TiC. Preferred elements among X are Ta, W, Mo, Nb, Zr, and V, much preferred elements are Ta, W, Mo, and Nb, and a particularly preferred element is W.

In the sintered body, each of Al₂O₃, TiC, XC, and (Ti,X)C forms crystal grains. (Ti,X)C is a carbide of Ti and X and solid solution.

The free carbon in the sintered body is a free component not chemically boded with Al₂O₃ or the carbides, and exists mainly at grain boundaries of Al₂O₃ and the carbides.

A content of all the carbides in the sintered body for the magnetic head slider, i.e., a total content of at least one of TiC and XC, and (Ti,X)C is 25 to 160 parts by volume, based on 100 parts by volume of Al₂O₃. There are no particular restrictions on volume percentages among TiC, XC, and (Ti,X)C, but a rate of (Ti,X)C is preferably as high as possible in order to enhance surface smoothness. The volume percentage of (Ti,X)C among TiC, XC, and (Ti,X)C tends to increase with rise of sintering temperature. The sintered body may contain at least one of TiC and XC, and, normally, the both are often contained.

A content of the free carbon in the sintered body for the magnetic head slider is 1 to 15 parts by volume, based on 100 parts by volume of a total of Al₂O₃ and all the carbides. The content of free carbon is preferably 3 to 7 parts by volume.

A volume ratio of the compounds and free carbon in the sintered body can be readily acquired from an area ratio of the components in a sectional photograph of the sintered body.

When the sintered body contains neither the carbide containing X and Ti, nor XC, but contains only TiC, surface smoothness tends to become insufficient. If the content of all the carbides including at least one of TiC and XC, and the carbide containing Ti and X is less than the aforementioned lower limit, the polishing rate and surface smoothness will tend to be insufficient. If the content of all the carbides is over the aforementioned upper limit, sinterability will tend to worsen. If the content of C is less than the aforementioned lower limit, the polishing rate will be insufficient. If the carbon content is over the aforementioned upper limit, surface smoothness will be insufficient.

A molar ratio of X and Ti in all the carbides is preferably 1:10 to 3:1. Furthermore, more preferably, a content of all the carbides is 70 to 160 parts by volume, based on 100 parts by volume of Al₂O₃, and the molar ratio of X and Ti in all the carbides is 1:3 to 3:1.

Furthermore, the sintered body for the magnetic head slider can further contain titania (TiO₂). A preferred content of titania is 0.5 to 10 parts by volume, based on 100 parts by volume of Al₂O₃. When the sintered body for the magnetic head slider contains titania, sinterability is enhanced to facilitate achievement of high strength.

The sintered body for the magnetic head slider may contain any other component as long as it does not affect the characteristics.

(Method of Producing Sintered Body for Magnetic Head Slider)

Subsequently, a first production method of the sintered body for the magnetic head slider as described above will be described.

The first step is to prepare an Al₂O₃ powder, a TiC powder, an XC (carbide of metal X) powder (where X is at least one element selected from the element group consisting of Ta, W, Mo, Nb, Zr, V, Cr, and Si), and a carbon powder, and, if necessary, to further prepare a titania powder as an additive.

Here an average particle size of the Al₂O₃ powder as a raw material is preferably 0.1-1 μm and more preferably 0.4-0.6 μm.

An average particle size of the TiC powder and XC powder is preferably 0.1-3 μm and more preferably 0.1-0.5 μm. The TiC powder and the XC powder may contain carbon.

An average particle size of the carbon powder is preferably 20-100 nm. The carbon powder can be, for example, a powder made of carbon such as carbon black or ethylene black.

An average particle size of the titania powder is preferably 0.1-3 μm and more preferably 0.5-1 μm.

Then these powders are mixed, for example, in an organic solvent such as ethanol, IPA, or 95% denatured ethanol to obtain a mixed powder. If water were used as a solvent, the solvent would chemically react with TiC to oxidize the TiC powder. Therefore, water is not applicable.

The Al₂O₃ powder, TiC powder, XC powder, and carbon powder are blended in the mixed powder so that the content of a total of TiC and XC is 25 to 160 parts by volume, based on 100 parts by volume of Al₂O₃, and so that the content of carbon is 1 to 15 parts by volume, based on 100 parts by volume of a total of Al₂O₃, TiC, and XC. The volume herein is not an apparent volume of powder such as bulk density, but is a real volume of each substance. It is easy to calculate a real volume of each substance on the basis of a weight of each substance and a real density of each substance.

A metal carbide powder such as TiC or XC normally contains approximately 0.1-0.5 wt % of free carbon. The aforementioned content of carbon is a content of carbon also including this free carbon.

A content of carbon is preferably 3 to 7 parts by volume, based on 100 parts by volume of a total of Al₂O₃, TiC, and XC. TiC and XC both are essential. A molar ratio of XC and TiC is preferably 1:3 to 3:1. Furthermore, when the total content of TiC and XC is 70 to 160 parts by volume, based on 100 parts by volume of Al₂O₃, the molar ratio of XC and TiC may be 1:10 to 3:1. In addition, if necessary, an additive such as titania powder may be added.

The blending of powders is preferably carried out in a ball mill or an attritor. The blending of powders is preferably carried out for about 10 to 100 hours. Mixing media in the ball mill or the attritor are preferably, for example, alumina balls or the like having the diameter of about 1-20 mm.

Next, the mixed powder is granulated by spray granulation. The granulation herein is effected, for example, by spray drying of the mixed powder in a hot blast of inert gas such as nitrogen or argon containing little oxygen, at about 60-200° C., and this obtains granules of the mixed powder in the above composition. Here the grain sizes of the granules are preferably, for example, about 50 μm-200 μm.

Next, if necessary, the aforementioned organic solvent is added to adjust the content of liquid in the granules so that the organic solvent is contained in the content of about 0.1 to 10% by weight in the granules. The organic solvent used for adjustment of the content of liquid can be, for example, an organic solvent such as ethanol, IPA, or 95% denatured ethanol and is normally the organic solvent used in the blending of powders. If water were used as the solvent herein, the solvent would react chemically with titanium carbide to oxidize the titanium carbide powder. Therefore, water is not applicable.

Then the granules are packed in a predetermined die and primarily compacted by cold press to obtain a compact. In this case, for example, the granules are filled in a metal or carbon die for formation of a disk having the inside diameter of 150 mm, and cold press is implemented, for example, under the pressure of about 5 to 15 MPa (about 50-150 kgf/cm²).

Subsequently, the resultant compact is hot pressed (HIP) to obtain a sintered body. For example, the sintering temperature is 1200-1750° C., the pressure 10-50 MPa (about 100-500 kgf/cm²), and the atmosphere is a non-oxidizing atmosphere such as vacuum, nitrogen, or argon. The non-oxidizing atmosphere is adopted in order to inhibit oxidation of titanium carbide. A carbon die is preferably used for compacting of the mixed powder. A sintering time of the compact is preferably about 1 to 3 hours. If the amount of the (Ti,X)C component, i.e., the solid solution component is increased in the sintered body, surface smoothness will tend to be enhanced, and the sintering temperature is preferably 1650-1750° C.

This completes the sintered body for the magnetic head slider. There are no particular restrictions on the shape of the sintered body for the magnetic head slider, and it can be, for example, a substrate of a disk shape having the diameter of 6 inches and the thickness of 2.5 mm, or a rectangular substrate.

Subsequently, a second production method of the sintered body for the magnetic head slider as described above will be described.

The first production method described above used the carbon powder, whereas the second production method uses an organic substance instead thereof. Specifically, first, an Al₂O₃ powder, a TiC powder, an XC powder, and an organic substance are mixed to obtain a mixture. There are no particular restrictions on the organic substance herein, but it can be, for example, polyvinyl alcohol, acrylic resin, butyral resin, or the like. The mixture may contain an additive such as titania powder according to need.

Subsequently, this mixture is thermally treated under a non-oxidizing atmosphere such as a vacuum atmosphere or a nitrogen atmosphere to carbonize the organic substance in the mixture. The carbonization conditions herein can be optionally and suitably set depending upon the type of the organic substance and others, and are, for example, a thermal treatment at 600° C. and for about 5 hours in a vacuum drying furnace or the like, which can obtain the mixed powder containing Al₂O₃, TiC, XC, and carbon and containing titania or the like according to need.

After that, this mixed powder is compacted and sintered in the same manner as in the first production method.

The production using the organic substance in this manner enables uniform dispersion of carbon and reduction in the time necessary for dispersion of carbon. The carbonized organic substance is also included as a carbon component in the aforementioned compact.

For obtaining a fine sintered body for the magnetic head slider, it is preferable to compact the mixed powder after carbonization of the organic substance as described above, but the organic substance may be carbonized after the compacting.

Specifically, after obtaining the mixture containing the Al₂O₃ powder, TiC powder, XC powder, organic substance, and others, this mixture is compacted in the same manner as in the first production method, before the carbonization. Then the compact of the mixture containing the organic substance is subjected to the thermal treatment as described above, to carbonize the organic substance, thereby obtaining the compact containing Al₂O₃, TiC, XC, carbon, and so on.

In the second production method, the contents of the respective powders in mixing the Al₂O₃ powder, TiC powder, XC powder, and organic substance and further mixing the titania powder or the like according to need to obtain the mixture may be preliminarily determined so that the amounts of Al₂O₃, TiC, XC, carbon, and titania in the mixed powder or in the compact after the carbonization of the mixture of those satisfy the contents defined in the first production method. This results in obtaining the compact in the composition similar to that in the first production method.

(Magnetic Head Slider)

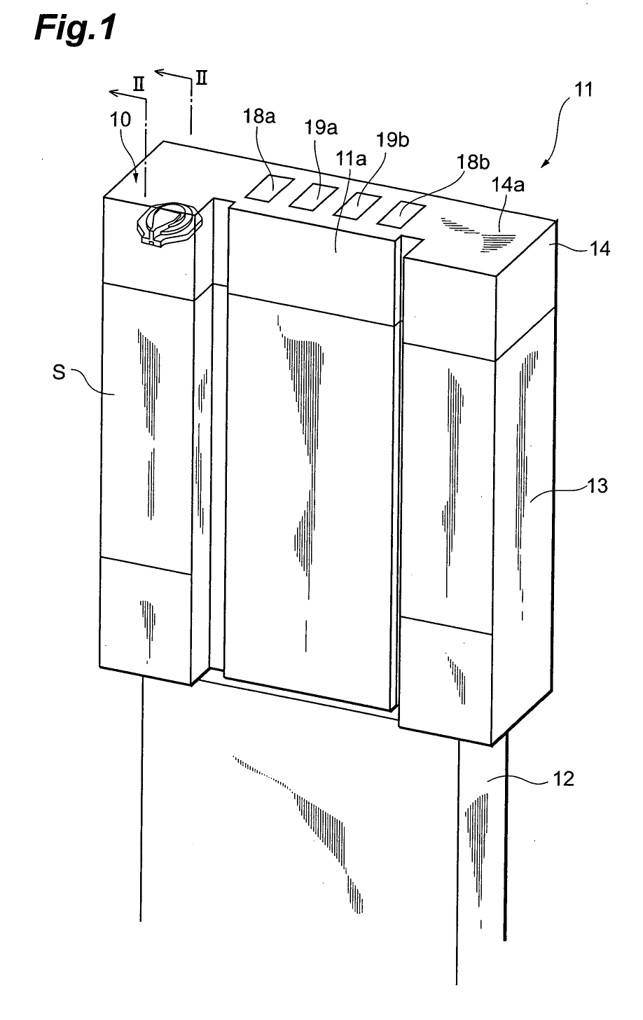

Next, a magnetic head slider using the sintered body for the magnetic head slider will be described with reference to FIG. 1.

The magnetic head slider 11 of the present embodiment has a thin-film magnetic head 10, and is mounted on a hard disk drive (not shown) equipped with a hard disk. This hard disk drive is configured to record and reproduce magnetic information on a recording surface of the hard disk rotating at high speed, by the thin-film magnetic head 10.

The magnetic head slider 11 of the embodiment of the present invention is of an approximately rectangular parallelepiped shape. In FIG. 1, the surface on this side in the magnetic head slider 11 is a recording medium-opposed surface to be opposed to the recording surface of the hard disk, and is called an Air Bearing Surface (ABS) S. A groove 11a is formed in the direction perpendicular to the track width direction in the air bearing surface.

As the hard disk rotates, the magnetic head slider 11 comes to float by air flow caused by the rotation, whereby the air bearing surface S is set apart from the recording surface of the hard disk. The air bearing surface S may be provided with a coating of DLC (Diamond-Like Carbon) or the like.

This magnetic head slider 11 is comprised of a substrate 13 made of the aforementioned material for the magnetic head slider, and a laminate 14 formed on this substrate 13 and incorporating the thin-film magnetic head 10. More particularly, in the present embodiment the substrate 13 has a rectangular parallelepiped shape and the laminate 14 is formed on a side face of the substrate 13.

An upper surface 14a of the laminate 14 forms an end face of the magnetic head slider 11 and the upper surface 14a of the laminate 14 is equipped with record pads 18a, 18b and reproduction pads 19a, 19b connected to the thin-film magnetic head 10. The thin-film magnetic head 10 is provided in the laminate 14 and is exposed in part from the air bearing surface S to the outside. In FIG. 1, the thin-film magnetic head 10 buried in the laminate 14 is indicated by solid lines in consideration of easier recognition.

The magnetic head slider 11 of this configuration is mounted on a gimbal 12 and is connected to an unrepresented suspension arm to constitute a head gimbal assembly.

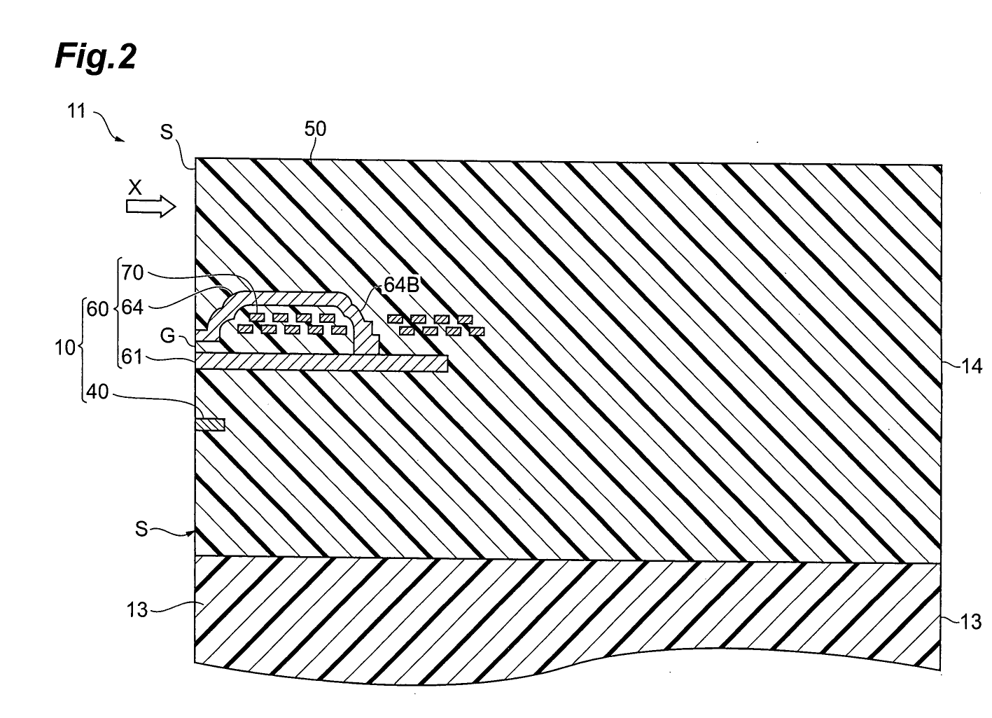

FIG. 2 is a schematic sectional view in a direction normal to the air bearing surface S and normal to the track width direction in the magnetic head slider 11 (a schematic sectional view along II-II in FIG. 1). As described above, the magnetic head slider 11 has the substrate 13 of the approximately rectangular plate shape, and the laminate 14 laid on the side face of this substrate 13. The laminate 14 has the thin-film magnetic head 10, and a coat layer 50 surrounding this thin-film magnetic head 10.

The thin-film magnetic head 10 has a GMR (Giant Magneto-Resistive) element 40 as a reading element for reading magnetic information on the hard disk, and an induction type electromagnetic conversion element 60 as a writing element for writing magnetic information on the hard disk, in order from the side close to the substrate 13, and is so called a composite thin-film magnetic head.

The electromagnetic conversion element 60 is one adopting the so-called longitudinal recording method, provided with a lower magnetic pole 61 and an upper magnetic pole 64 in order from the substrate 13 side, and further provided with a thin-film coil 70.

Ends of the lower magnetic pole 61 and the upper magnetic pole 64 on the air bearing surface S side are exposed in the air bearing surface S, and the exposed portions of the lower magnetic pole 61 and the upper magnetic pole 64 are spaced from each other by a predetermined distance to form a recording gap G. On the other hand, an end 64B of the upper magnetic pole 64 on the far side from the air bearing surface S is bent toward the lower magnetic pole 61, and this end 64B is magnetically coupled to an end of the lower magnetic pole 61 on the far side from the air bearing surface S. In this configuration, the upper magnetic pole 64 and the lower magnetic pole 61 form a magnetic circuit with the gap G in between.

The thin-film coil 70 is arranged to surround the end 64B of the upper magnetic pole 64 and is configured to generate a magnetic field in the recording gap G by electromagnetic induction, thereby recording magnetic information on the recording surface of the hard disk.

The GMR element 40 has a multilayer structure, though not shown, and is exposed in the air bearing surface S. The GMR element 40 is configured to detect a change of a magnetic field from the hard disk by making use of the magneto-resistance effect, to read the magnetic information.

The GMR element 40 and the electromagnetic conversion element 60 are spaced from each other by the insulating coat layer 50, and the upper magnetic pole 64 and the lower magnetic pole 61 are also spaced from each other by the insulating coat layer 50. The thin-film magnetic head 10 itself is also coated by the coat layer 50 except for the air bearing surface S. The coat layer 50 is made mainly of an insulating material such as alumina. Specifically, the coat layer is normally an alumina layer made by sputtering or the like. The alumina layer of this type normally has an amorphous structure.

The thin-film magnetic head 10 may be of the vertical recording method, instead of the longitudinal recording method. The GMR element 40 may be replaced by an AMR (Anisotropy Magneto-Resistive) element making use of the anisotropic magneto-resistance effect, a TMR (Tunnel-type Magneto-Resistive) element making use of the magneto-resistance effect occurring at a tunnel junction, or the like.

Furthermore, the coat layer 50 may further contain a magnetic layer or the like for magnetically insulating the GMR element 40 from the electromagnetic conversion element 60.

Subsequently, a production method of the magnetic head slider 11 as described above will be described.

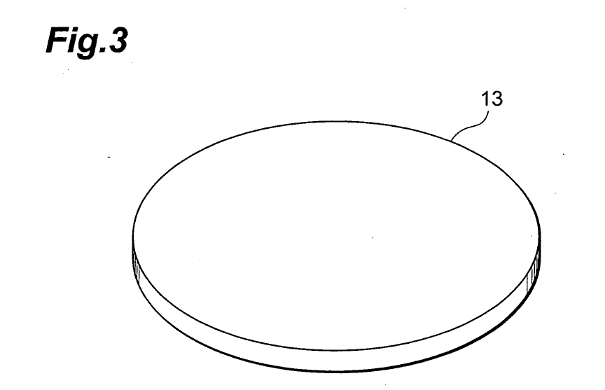

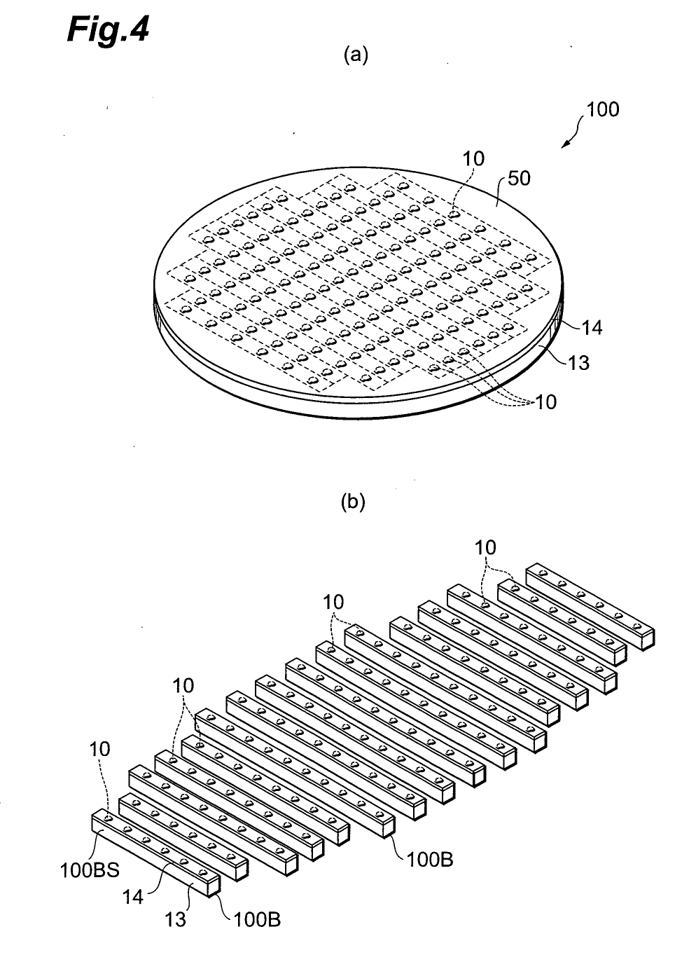

The first step is to prepare a substrate 13 formed in a disk wafer shape from the aforementioned sintered body for the magnetic head slider, as shown in FIG. 3. Next, as shown in FIG. 4(a), a laminate 14 including thin-film magnetic heads 10 and coat layer 50 is laid on this substrate 13 by a well-known technique. The laminate 14 herein is formed so that a number of thin-film magnetic heads 10 are arrayed in a matrix in the laminate 14.

Subsequently, the substrate 13 with the laminate 14 thereon is cut in a predetermined shape and size. In this case, for example, the substrate is cut as indicated by dashed lines in FIG. 4(a) to form bars 100B in such a structure that a plurality of thin-film magnetic heads 10 are arranged on a line and that these thin-film magnetic heads 10 are exposed each in a side face 100BS, as shown in FIG. 4(b).

Then a so-called lapping step is carried out to polish the side face 100BS of each bar 100B to form the air bearing surface S. In this lapping step, the substrate 13 and the laminate 14 thereon are polished simultaneously and in the direction crossing the stack direction (i.e., the direction of arrow X in FIG. 2).

In the present embodiment, the substrate 13 is made from the aforementioned sintered body for the magnetic head slider. Therefore, the polishing rate of this substrate 13 becomes sufficiently higher than the polishing rate of the substrate made from the conventional AlTiC sintered body, and the polishing rate of this substrate 13 becomes approximately equal to the polishing rate of the laminate 14 incorporating the thin-film magnetic heads 10.

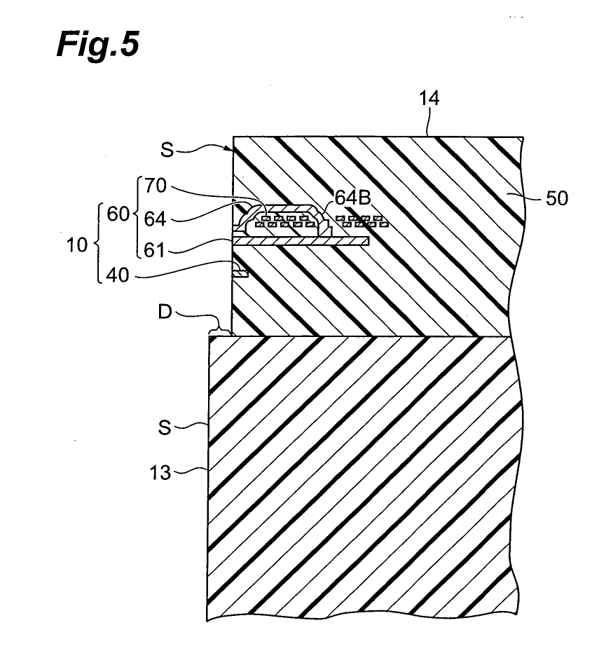

Therefore, after the lapping, the difference between polishing amounts of the laminate 14 and the substrate 13 is extremely small, so that the level difference D (cf. FIG. 5) between the laminate 14 and the substrate 13 becomes much smaller than before. This makes, for example, the air bearing surface S almost flat. Specifically, the level difference D can be made not more than 1.2 nm, for example.

In this sintered body, the maximum height Rmax (JIS B 0601-1982) of the polished surface is sufficiently small and smoothness of the surface is extremely high.

Therefore, it becomes feasible to appropriately construct a femto slider or a slider in a size smaller than it, and it becomes easy to achieve recording in a higher density. Furthermore, the substrate 13 of the present embodiment also has sufficient strength and thus has satisfactory reliability.

### EXAMPLES

The present invention will be described below in further detail with examples and comparative examples, but it is noted that the present invention is by no means intended to be limited to these examples.

In the examples, a plurality of substrates were made from sintered bodies for the magnetic head slider different in constituent materials and the polishing rate and surface roughness were measured for each of them.

### Examples 1-9

First, an Al₂O₃ powder (average particle size 0.5 μm), a TiC powder (average particle size 0.3 μm and carbon content 0.1 wt %), a WC powder (average particle size 0.1 μm and carbon content 0.1 wt %), a TiO₂ powder (average particle size 0.6 μm), and a carbon powder (carbon black, average particle size 35 nm) were weighed by predetermined amounts, respectively, they were pulverized with IPA (isopropyl alcohol; boiling point 82.4° C.) in a ball mill for 30 minutes, and thereafter they were spray-granulated at 150° C. in nitrogen to obtain granules.

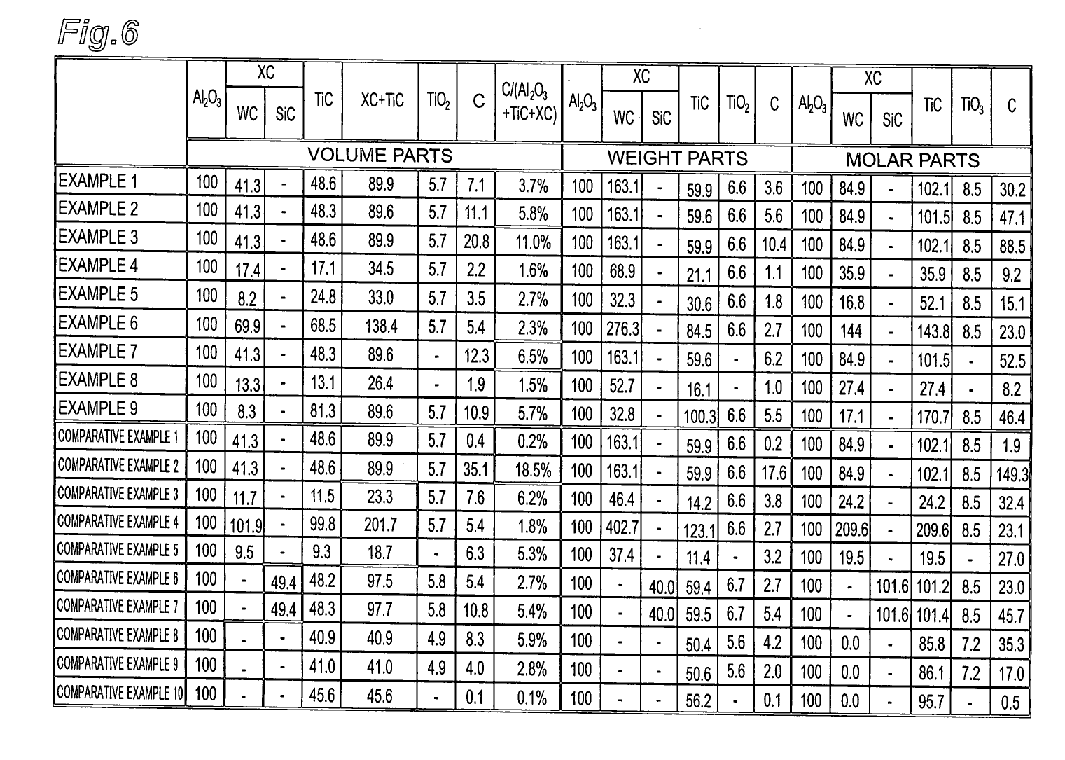

The Al₂O₃ powder, TiC powder, WC powder, carbon powder, and TiO₂ powder were mixed in the contents satisfying the conditions in FIG. 6, in the granules. The volume ratios and molar ratios are data converted from weight ratios on the basis of the real densities and molecular weights. The real densities of Al₂O₃, TiC, WC, TiO₂, and carbon used were 3990, 4920, 15770, 4260, and 2000 kg/m³, respectively.

Subsequently, the resultant granules were primarily compacted under about 0.5 MPa (50 kgf/cm²), and thereafter sintered in a vacuum atmosphere at a predetermined sintering temperature and under the press pressure of about 30 MPa (about 300 kgf/cm²) for one hour by the hot press method to obtain the examples of the sintered bodies for the magnetic head slider. The sintering temperature was 1720° C. in Example 1, and 1700° C. in Examples 2-8.

After that, each of these was cut into cut pieces in the size of about 20×20×1.8 mm, and a surface of each cut piece was preliminarily polished with oil on a resin surface plate of 2000# for 10 minutes. Thereafter, this cut piece was fully polished with a one-side polisher, using a slurry containing diamond particles in the diameter of 0.1 μm. The polishing conditions for the main polishing were the rotation speed of a tin plate of 37.5 rotations per min, the load of 2550 g, the rotation speed of an oskar motor of 55 rotations per min, and the polishing time of 40 minutes. Thicknesses before and after the polishing were measured and a difference between the thicknesses was divided by the polishing time to acquire a polishing rate of each example. Surface roughnesses Ra, Rmax (JIS B 0601-1982) of surfaces of the sintered bodies after the polishing were measured with a surface roughness measuring apparatus (AFM).

### Comparative Examples 1-10

Comparative Example 1 was the same as Example 3 except that no carbon powder was added. Comparative Example 2 was the same as Example 3 except that the added amount of carbon powder was 34.6 parts by volume.

Comparative Examples 3 and 4 were the same as Example 3 except that the total amount of WC and TiC, and the carbon amount were set as shown in FIG. 6.

Comparative Example 5 was the same as Example 3 except that no titania was added and that the total amount of WC and TiC, and the carbon amount were set as shown in FIG. 6.

Comparative Examples 6 and 7 were the same as Example 3 except that SiC was used instead of WC and that the amounts of SiC, TiC, and C were set as shown in FIG. 6.

Comparative Examples 8 and 9 were the same as Example 3 except that no WC was added and that the amounts of TiC, TiO₂, and C were set as shown in FIG. 6.

Comparative Example 10 was the same as Example 3 except that none of WC, carbon, and titania was added and that the amount of TiC was set as shown in FIG. 6.

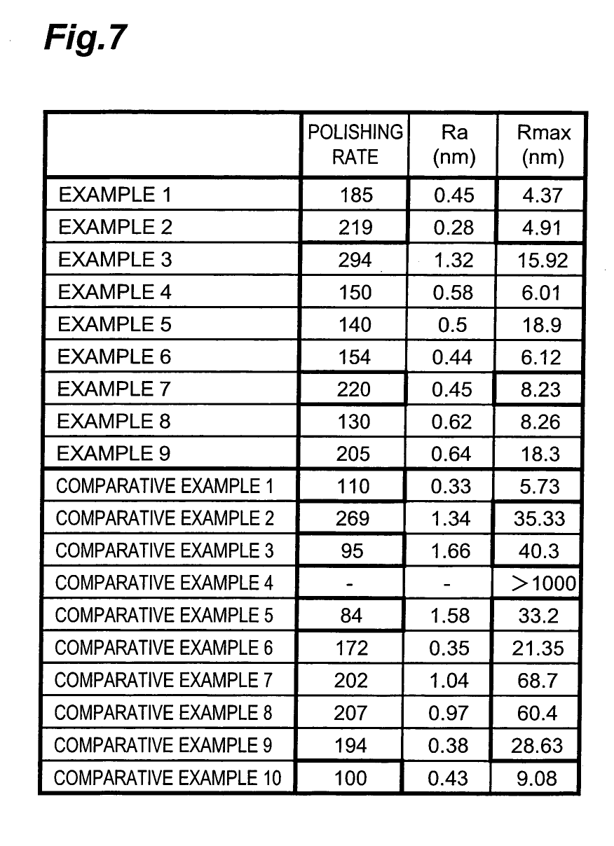

These conditions are shown as a table in FIG. 6 and the characteristics of the sintered bodies thus made are shown as a table in FIG. 7. The polishing rates were determined as follows: the polishing rate in Comparative Example 10 was defined as 100 and the polishing rate in each of the examples and comparative examples was expressed as a ratio thereof to the polishing rate of Comparative Example 10. The polishing rate in Comparative Example 10 was 1.7 μm/10 min.

The cut pieces in Examples 1-9 demonstrated sufficiently high polishing rates (120 or more), and satisfactory surface smoothness (Rmax not more than 20 nm). On the other hand, the polishing rate and surface smoothness were insufficient in Comparative Examples 1-10 the compositions of which did not satisfy the aforementioned conditions.

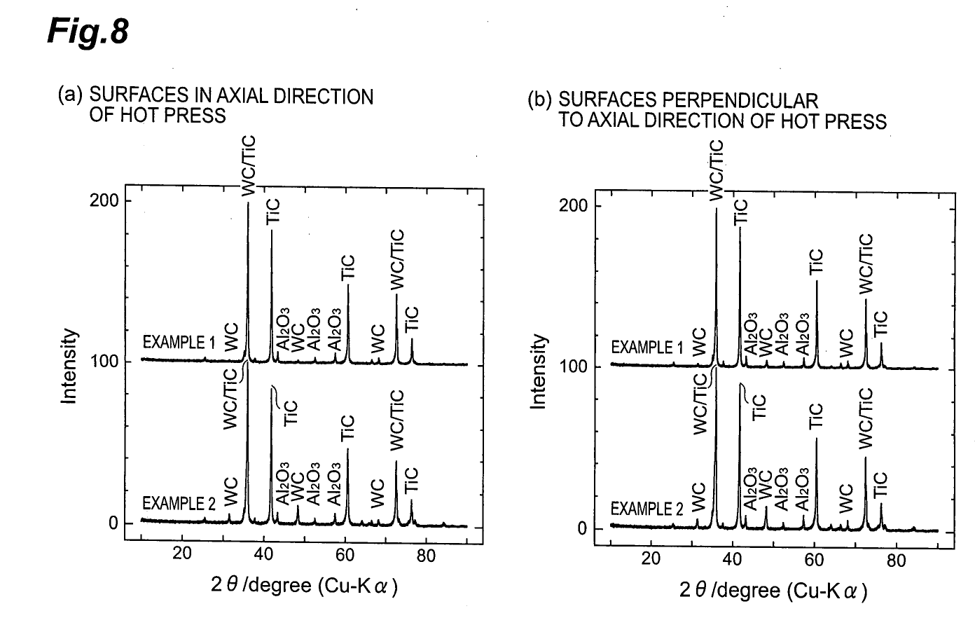

XRD data of Examples 1 and 2 are presented in FIG. 8 wherein (a) shows surfaces in the axial direction of hot press and (b) surfaces perpendicular to the axial direction of hot press. Example 1, in which the temperature is higher than in Example 2, indicates that peaks of WC decrease and the solid solution increases. The existence of the solid solution was also confirmed with TEM.

What is claimed is:

1. A sintered body for a magnetic head slider comprising at least one of TiC and XC, a carbide containing Ti and X, Al₂O₃, and free carbon, where X is at least one element selected from the group consisting of Ta, W, Mo, Nb, Zr, V, and Cr,
wherein a content of all the carbides including the at least one of TiC and XC, and the carbide containing Ti and X is 25 to 160 parts by volume, based on 100 parts by volume of Al₂O₃, and
wherein a content of the free carbon is 1 to 15 parts by volume, based on 100 parts by volume of a total of Al₂O₃ and all the carbides.

2. A sintered body for a magnetic head slider according to claim 1, wherein the content of the free carbon is 3 to 7 parts by volume, based on 100 parts by volume of the total of Al₂O₃ and all the carbides.

3. A sintered body for a magnetic head slider according to claim 1, wherein a molar ratio of X and Ti in all the carbides is 1:3 to 3:1.

4. A sintered body for a magnetic head slider according to claim 1, wherein the content of all the carbides is 70 to 160 parts by volume, based on 100 parts by volume of Al₂O₃, and
wherein a molar ratio of X and Ti in all the carbides is 1:10 to 3:1.

5. A magnetic head slider comprising a substrate made from a sintered body, and a laminate incorporating a thin-film magnetic head, which is formed on the substrate,
wherein the sintered body comprises at least one of TiC and XC, a carbide containing Ti and X, Al₂O₃, and free carbon, where X is at least one element selected from the group consisting of Ta, W, Mo, Nb, Zr, V, and Cr,
wherein a content of all the carbides including the at least one of TiC and XC, and the carbide containing Ti and X is 25 to 160 parts by volume, based on 100 parts by volume of Al₂O₃, and
wherein a content of the free carbon is 1 to 15 parts by volume, based on 100 parts by volume of a total of Al₂O₃ and all the carbides.

6. A magnetic head slider according to claim 5, wherein the sintered body contains 3 to 7 parts by volume of the free carbon, based on 100 parts by volume of a total of Al₂O₃ and all the carbides.

7. A magnetic head slider according to claim 5, wherein in the sintered body, a molar ratio of X and Ti in all the carbides is 1:3 to 3:1.

8. A magnetic head slider according to claim 5, wherein the content of all the carbides is 70 to 160 parts by volume, based on 100 parts by volume of Al₂O₃, and
wherein a molar ratio of X and Ti in all the carbides is 1:10 to 3:1.

9. A method of producing a sintered body for a magnetic head slider, which comprises a step of sintering in a non-oxidizing atmosphere a compact of powder comprising Al₂O₃, TiC, XC, and carbon, where X is at least one element selected from the element group consisting of Ta, W, Mo, Nb, Zr, V, Cr, and Si,
wherein a total content of TiC and XC is 25 to 160 parts by volume, based on 100 parts by volume of Al₂O₃, and wherein a content of the carbon is 1 to 15 parts by volume, based on 100 parts by volume of a total of Al₂O₃, TiC, and XC.

10. A method according to claim 9, wherein the compact contains 3 to 7 parts by volume of carbon, based on 100 parts by volume of the total of Al₂O₃, TiC, and XC.

11. A method according to claim 9, wherein in the compact, a molar ratio of XC and TiC is 1:3 to 3:1.

12. A method according to claim 9, wherein in the compact, a total content of TiC and XC is 70 to 160 parts by volume, based on 100 parts by volume of Al₂O₃, and wherein a molar ratio of XC and TiC is 1:10 to 3:1.

13. A method according to claim 9, further comprising a step of compacting a mixed powder containing Al₂O₃, TiC, XC, and carbon to form the compact.

14. A method according to claim 9, further comprising a step of mixing Al₂O₃, TiC, XC, and an organic material to obtain a mixture, subjecting the mixture to a thermal treatment in a non-oxidizing atmosphere to carbonize the organic material in the mixture, thereby obtaining a mixed powder, and compacting the mixed powder to form the compact.

15. A method according to claim 9, further comprising a step of mixing Al₂O₃, TiC, XC, and an organic material to obtain a mixture, compacting the mixture, and subjecting the compacted mixture to a thermal treatment in a non-oxidizing atmosphere to carbonize the organic material in the mixture, to obtain the compact.

16. A method according to claim 9, wherein the step of sintering the compact comprises performing the sintering by an HIP method.
